(19) United States
(12) Patent Application Publication
(10) Pub. No.: US 2019/0291777 A1
(43) Pub. Date: Sep. 26, 2019

(54) ELECTRIC POWER STEERING DEVICE

(71) Applicant: HONDA MOTOR CO., LTD., Tokyo (JP)

(72) Inventors: Jun ISHIO, WAKO-SHI (JP); Toshihiro YODA, WAKO-SHI (JP); Kenji TSUYAMA, WAKO-SHI (JP)

(21) Appl. No.: 16/360,837

(22) Filed: Mar. 21, 2019

(30) Foreign Application Priority Data
Mar. 23, 2018 (JP) 2018-055450

(51) Int. Cl. B62D 5/04; B62D 6/00

(52) U.S. Cl. CPC B62D 5/0463; B62D 6/00

(57) ABSTRACT

A rack axial force is estimated depending on a steering torque detected by a torque sensor and a motor actual current passed through an assist motor, a standard steering torque of the steering is calculated based on the estimated rack axial force, and the motor actual current is feedback-controlled by a FB control section in such a manner that the steering torque of the steering will be the standard steering torque.

### CROSS-REFERENCE TO RELATED APPLICATION

This application is based upon and claims the benefit of priority from Japanese Patent Application No. 2018-055450 filed on Mar. 23, 2018, the contents of which are incorporated herein by reference.

### BACKGROUND OF THE INVENTION

### Field of the Invention

The present invention relates to an electric power steering device in which an assist torque due to a motor is imparted to manual operation of a steering (a steering operating element) to reduce an operation torque (called a steerage torque, a steering torque, or a handle torque) in the steering operation.

### Description of the Related Art

For example, in Japanese Laid-Open Patent Publication No. 2005-170257 (hereafter, called JPA2005-170257), it is described that a catching feeling occurs during fine operation of steering operation, and that this is sometimes due to effects of a friction torque of a steering system ([0003] of JPA2005-170257).

In order to reduce this, in an electric power steering device of JPA2005-170257, first, when a steering torque due to the steering operation has occurred, presence/absence of rotation of a motor is detected, and when judged to be before rotation start, a static friction torque is assumed to occur ([0009] of JPA2005-170257).

It is further described that when the static friction torque has been assumed to occur, next, a current value obtained by multiplying a differential value of the steering torque by a certain coefficient is inputted to the motor as a compensation current of the static friction torque, whereby effects of the static friction torque can be reduced more than conventionally, and a good steering feeling can be achieved ([0010] of JPA2005-170257).

### SUMMARY OF THE INVENTION

However, in the electric power steering device disclosed in JPA2005-170257, a catching feeling was known to be left during turning-back (or transition) of the steering, and as a result, stability of steering force with respect to the steering operation was found to be lacking.

The present invention was made in view of such a problem, and has an object of providing an electric power steering device that enables stability of steering force to be improved by suppressing a catching feeling of a steering.

An electric power steering device according to the present invention is an electric power steering device in which a steering assist force appropriate to steering operation is applied to a steering mechanism by an assist motor, and includes:

a torque sensor configured to detect a steering torque due to the steering operation;

a current sensor configured to detect a motor current flowing in the assist motor; and

a controller configured to estimate a rack axial force depending on the steering torque and the motor current, calculate a standard steering force of the steering based on the estimated rack axial force, and feedback-control the motor current in a manner that the steering torque of the steering will be the standard steering force.

Due to the present invention, the steering torque of the steering is controlled so as to be the standard steering force, hence stability of steering force with respect to the steering operation is improved, and as a result, a catching feeling during turning-back of the steering can be suppressed.

In this case, it is preferable that there be further included a rotation angle sensor configured to detect a rotation angle of the assist motor,

wherein the controller is configured to calculate the standard steering force, based on a steering angle and a steering angular speed calculated from the rotation angle, in addition to the estimated rack axial force.

By configuring in this way, calculation accuracy of the standard steering force can be increased, and stability of steering force with respect to the steering operation is more improved.

Note that the controller may be configured to set the estimated rack axial force to a rack axial force from which a viscosity compensation axial force based on a viscosity compensation current has been removed.

As a result, calculation accuracy of the standard steering force can be further increased, and stability of steering force with respect to the steering operation can be even more improved.

Due to the present invention, the steering torque of the steering is controlled so as to be the standard steering force, hence stability of steering force with respect to the steering operation is improved, and as a result, a catching feeling during turning-back of the steering can be suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of an electric power steering device according to an embodiment;

FIG. 2 is a schematic circuit block diagram of the electric power steering device including a detailed configuration of a motor control device, in FIG. 1;

FIG. 3 is an explanatory diagram of a base assist map;

FIG. 4 is a block diagram showing a detailed configuration of a standard steering force determining section and its input/output configuring elements; and

FIG. 5A is a characteristic diagram showing angle/force characteristics after improvement according to the embodiment, and FIG. 5B is a characteristic diagram showing angle/force characteristics before improvement according to a comparative example.

### DESCRIPTION OF THE PREFERRED EMBODIMENTS

### [Configuration]

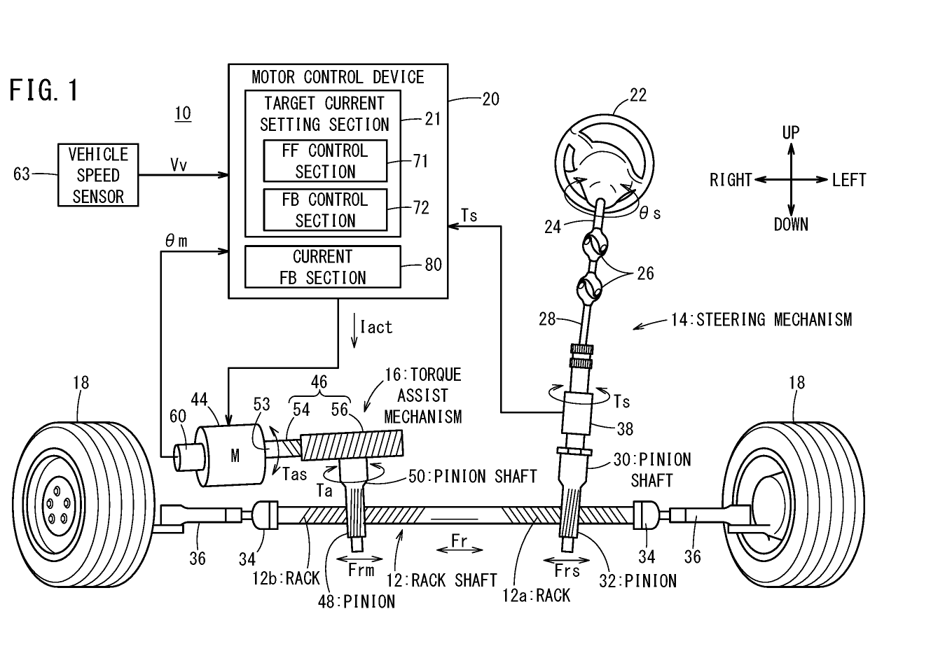

FIG. 1 is a schematic configuration diagram of an electric power steering device 10 according to the present embodiment.

Note that in FIG. 1, “up/down” with which the arrows are marked at top right indicate a vehicle up-down direction (a vertical up-down direction), and “left-right” with which the arrows are marked at top right indicate a vehicle width direction (a left-right direction).

The electric power steering device 10 is a so-called dual pinion type electric power steering device, and basically includes: a steering mechanism 14 having a rack shaft 12 that extends in the left-right direction; a torque assist mechanism 16 disposed on a side of one end of the rack shaft 12; turning wheels 18 being left and right front wheels; a motor control device (a control device) 20; and a motor-for-assist (an assist motor) 44 drive-controlled by the motor control device 20.

The motor control device 20 is configured as an ECU (Electronic Control Unit), for example. The ECU is a calculator including a microcomputer, has the likes of a CPU, a memory, and in addition, an input/output device such as an A/D converter and a D/A converter, and a timer as a clocking section, and by the CPU reading and executing a program recorded in the memory, functions as a various function achieving section that will be described in detail later.

Note that the embodiment of the electric power steering device according to the present invention is not limited to the dual pinion type of the kind shown in FIG. 1, and may be applied to an appropriate form, such as a column assist type, a belt drive type, and so on.

The steering mechanism 14 includes the following, in addition to the above-described rack shaft 12, namely: a steering wheel 22 as a steering operating element that is operated (steered) by a driver (an operator); a steering shaft 24 that rotates in the left-right direction by operation of the steering wheel 22; and a pinion shaft 30 that is provided below the steering shaft 24 via a pair of universal joints 26 and an intermediate shaft 28 (regarded as part of the steering shaft), and to which a steering force from the steering wheel 22 is transmitted.

The steering mechanism 14 further includes: the rack shaft 12 where there is formed a rack 12a that engages with a pinion 32 of the pinion shaft 30; and a torque sensor 38 that detects a torque that has been imparted to the steering shaft 24 by a driver steering force, that is, a steering torque (an operation torque) Ts.

The turning wheels 18 are respectively coupled, via a universal joint 34 and a tie rod 36, to both ends along an axial direction of the rack shaft 12.

When the driver operates the steering wheel 22, their steering force is transmitted to the rack shaft 12 via the pinion 32, and the rack shaft 12 is displaced to left or right along the vehicle width direction, whereby the turning wheels 18 are turned. That is, the steering mechanism 14 mechanically couples the steering wheel 22 configuring the steering mechanism 14 and the turning wheels 18.

On the other hand, the torque assist mechanism 16 includes: the rack shaft 12; the assist motor 44; a worm gear mechanism (a speed reducing mechanism) 46; and a pinion shaft 50 where there is formed a pinion 48 that engages with a rack 12b of the rack shaft 12.

The worm gear mechanism 46, although depicted integrally in FIG. 1, includes: a worm 54 coupled to a main shaft 53 of the assist motor 44; and a worm wheel 56 mutually engaging with this worm 54.

The worm wheel 56 is axially mounted on the pinion shaft 50. Due to this worm gear mechanism 46, that functions as the speed reducing mechanism, rotary motion transmitted from the assist motor 44 has its speed reduced, and rotary motion of the pinion shaft 50 that has been boosted by having its speed reduced is transmitted to the turning wheels 18 via the rack shaft 12, and, at the same time, is transmitted to the steering shaft 24 via the rack shaft 12, the pinion 32, and the pinion shaft 30.

In the torque assist mechanism 16, a target current Itar is set by a target current setting section 21 {(including a feedforward control section (FF control section) 71 and a feedback control section (FB control section) 72)} of the motor control device 20, depending on the steering torque Ts detected by the torque sensor 38, and the assist motor 44 is drive-controlled by a motor actual current Iact feedback-controlled by a current feedback section (current FB section) 80 so as to match this target current Itar.

An assist torque Tas generated by the assist motor 44 based on the motor actual current Iact is transmitted to the rack shaft 12, via the worm gear mechanism 46 and the pinion shaft 50, as an assist torque Ta (an assist effort) with respect to the steering force of the driver (a value that can be calculated from the steering torque Ts) that has been imparted to the steering wheel 22.

This assist effort (assist torque Ta) and the steering force of the steering wheel 22 due to the driver (the steering torque Ts) are synthesized to be configured as a rack axial force Fr displacing the rack shaft 12, and the rack axial force Fr turns the turning wheels 18.

Note that although in the present embodiment, a torsion bar type torque sensor is used as the torque sensor 38 provided in the pinion shaft 30 of the steering mechanism 14, an appropriate torque sensor such as a magnetostriction type may be used.

The assist motor 44 is provided with a resolver (a rotation sensor) 60 that detects a motor rotation angle θm as a rotation position of the main shaft 53 of the assist motor 44. There may be used as the rotation sensor attachable to the assist motor 44 the likes of a rotary encoder, besides the resolver 60.

A vehicle speed Vv detected by a vehicle speed sensor 63 is acquired by the motor control device 20, and is available for utilization when generating the assist torque Ta, and so on.

### [Configuration of Target Current Setting Section 21]

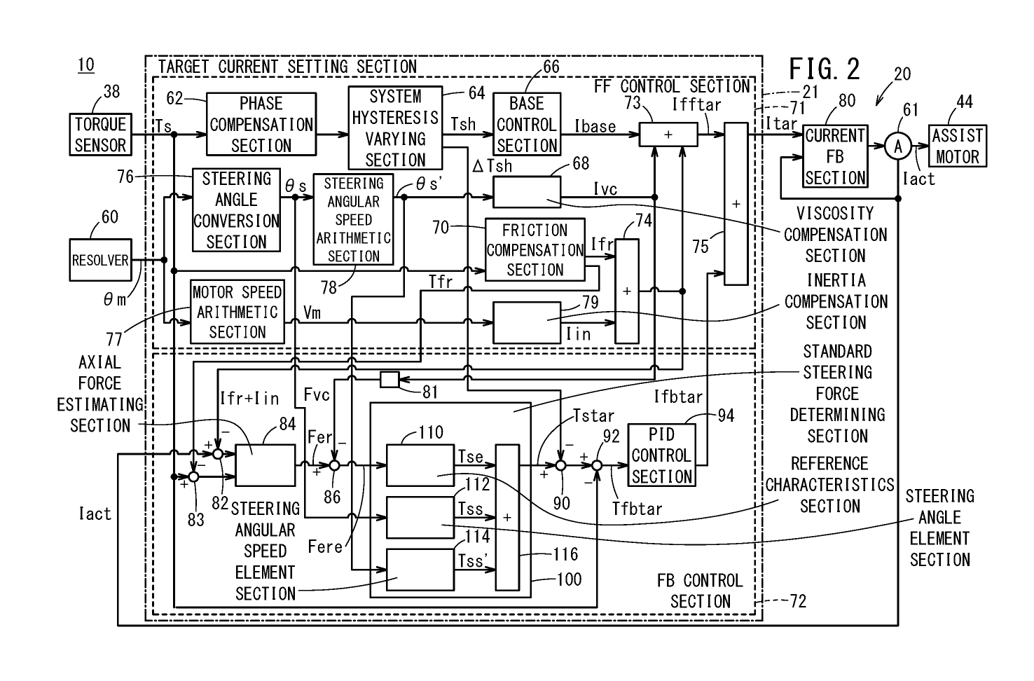

FIG. 2 is a schematic circuit block diagram of the electric power steering device 10 including a detailed configuration of the target current setting section 21 pertaining to an essential part of the present invention.

Configurations of the motor control device 20 and the target current setting section 21 will be described in detail below with reference also to FIG. 2.

The motor control device 20 is configured from the target current setting section 21 and the current FB section 80.

The target current setting section 21 is configured from: the FF control section (the feedforward control section, an ordinary control section, a conventional control section) 71 that generates a feedforward target current (FF target current) Ifftar being an ordinary (conventional) target current; and the FB control section/2 that generates a feedback target current (FB target current) Ifbtar pertaining to an essential part of the present embodiment.

The FF target current Ifftar and the FB target current Ifbtar are added (synthesized) by an adder (a synthesizer) 75 to be configured as the target current Itar, and inputted to the current FB section 80. The current FB section 80 performs PID (proportion/integration/differentiation) feedback control such that the motor actual current Iact detected by a current sensor 61, as well as being inputted to the assist motor 44, will become the target current Itar.

The FF control section 71 includes a phase compensation section 62, a system hysteresis varying section (a system-hys varying section) 64, a base control section 66, a steering angle conversion section 76, a steering angular speed arithmetic section 78, a viscosity compensation section 68, a motor speed arithmetic section 77, a friction compensation section 70, an inertia compensation section 79, and adders 73 to 75.

The FB control section 72 includes a current/axial force conversion section 81, subtractors 82, 83, an axial force estimating section 84, a subtractor 86, a standard steering force determining section 100, subtractors 90, 92, and a proportion/integration/differentiation control section (PID control section) 94.

The standard steering force determining section 100 includes a reference characteristics section 110, a steering angle element section 112, a steering angular speed element section 114, and an adder 116.

The target current setting section 21 of the motor control device 20, configured as described above, receives input from respective sensors as follows, namely, is inputted with the motor rotation angle θm from the resolver 60, is inputted with the steering torque Ts from the torque sensor 38, and furthermore, is inputted with the motor actual current Iact from the current sensor 61 inserted between the current FB section 80 and an input terminal of the assist motor 44. Note that the current sensor 61 is incorporated in the current FB section 80, of the motor control device 20.

Furthermore, the vehicle speed Vv detected by the vehicle speed sensor 63 (refer to FIG. 1) is acquired by the motor control device 20, and although not illustrated due to the complication that would result, is inputted to be available for utilization, in required configuration elements within the FF control section 71 and the FB control section 72 configuring the target current setting section 21.

The motor rotation angle θm of the main shaft 53 of the assist motor 44 detected by the resolver 60 is inputted to the steering angle conversion section 76 and the motor speed arithmetic section 77.

The steering angle conversion section 76 converts the motor rotation angle θm into a steering angle θs of the steering wheel 22, taking account of a speed reduction ratio of the worm gear mechanism 46, and inputs the steering angle θs to the steering angular speed arithmetic section 78 and the steering angle element section 112 in the standard steering force determining section 100.

Note that although component costs and attachment costs will increase, a configuration may be adopted whereby the steering angle θs is detected by mounting a dedicated angle sensor in the steering shaft 24.

The steering angular speed arithmetic section 78 is configured by a differentiator, time-differentiates the steering angle θs, and inputs the time-differentiated steering angle θs as a steering angular speed θs′ to the viscosity compensation section 68 and to the steering angular speed element section 114 in the standard steering force determining section 100.

The motor speed arithmetic section 77 is configured by a differentiator, time-differentiates the motor rotation angle θm, and inputs the time-differentiated motor rotation angle θm to the inertia compensation section 79 as a motor speed Vm.

The steering torque Ts detected by the torque sensor 38 is inputted to the phase compensation section 62, the friction compensation section 70, the axial force estimating section 84, a minuend terminal of the subtractor 83, and a subtraction terminal of the subtractor 92.

### [Operation of FF Control Section 71, in Target Current Setting Section 21]

In order to compensate a response delay portion of the steering mechanism 14, the phase compensation section 62 inputs to the system hysteresis varying section 64 the steering torque Ts after a phase compensation in which a phase of the steering torque Ts generated by the torque sensor 38 based on operation of the steering wheel 22 by the driver, is advanced.

The system hysteresis varying section 64, as well as inputting the base control section 66 with a steering torque Tsh being the phase-compensated steering torque Ts after impartation of a hysteresis torque ΔTsh that, depending on a steering state (turning-forward, turning-back (the transition from turning-forward to returning), returning), adds a torque during turning-forward, and subtracts a torque during returning, inputs a subtraction terminal of the subtractor 90 of the FB control section 72 with the hysteresis torque ΔTsh.

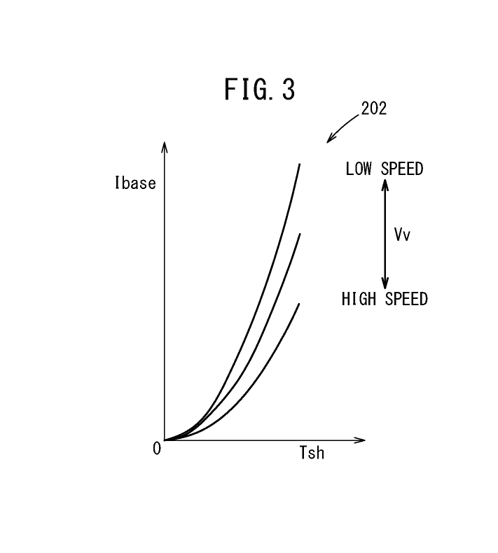

The base control section 66 refers to a base assist map (base assist characteristics) 202 shown in FIG. 3, and generates a base current Ibase appropriate to the steering torque Tsh. Specifically, the base control section 66 generates the base current Ibase where the larger the steering torque Tsh becomes, the larger a current value will be, and the larger a gradient will be. In this case, the base current Ibase is generated such that the higher the vehicle speed Vv becomes, the smaller the base current Ibase will be.

In other words, the base control section 66 generates the base current Ibase referring to the base assist map 202 in which the base current Ibase increases like a quadratic function with respect to the steering torque Tsh.

The base current Ibase generated by the base control section 66 is inputted to the adder 73.

In order to secure convergence of vehicle behavior during running, in other words, in order to improve convergence of the steering during running, the viscosity compensation section 68 refers to a viscosity compensation map (viscosity compensation characteristics) to calculate a viscosity compensation current Ivc, based on the steering angular speed θs′ and the vehicle speed Vv, and inputs the viscosity compensation current Ivc to the adder 73 and the current/axial force conversion section 81.

Note that the viscosity compensation map for example has characteristics of increasing like a square root (SQRT) function as the steering angular speed θs′ increases, and increasing proportionally as the vehicle speed Vv increases.

In order to suppress assist delay occurring in the assist motor 44, the friction compensation section 70, as well as generating based on the steering torque Ts a friction compensation torque Tfr that takes a certain positive value when a time differential value of the steering torque Ts is a positive value and takes a certain negative value when the time differential value of the steering torque Ts is a negative value, and inputting the friction compensation torque Tfr to a subtraction terminal of the subtractor 83 of the FB control section 72, generates a friction compensation current Ifr obtained by unit-converting the friction compensation torque Tfr ([Nm]→[A]), and inputs the friction compensation current Ifr to the adder 74. That is, the friction compensation section 70 generates a compensation signal by extracting a friction occurring process (element) from the steering torque Ts.

In order to remove effects on an assist torque (a steering assist force) of inertia of the assist motor 44 and the torque assist mechanism 16, the inertia compensation section 79 time-differentiates the motor speed Vm, generates a unit-converted inertia compensation current Iin appropriate to the motor speed Vm, and inputs the inertia compensation current Iin to the adder 74.

The adder 74 inputs to the adder 73 and a subtraction terminal of the subtractor 82 of the FB control section 72 an addition value of the friction compensation current Ifr and the inertia compensation current Iin (Ifr+Iin).

The adder 73 inputs an addition value of the base current Ibase, the viscosity compensation current Ivc, the friction compensation current Ifr, and the inertia compensation current Iin to the adder 75 as the feedforward target current (FF target current) Ifftar.

### [Operation of FB Control Section 72, in Target Current Setting Section 21]

The subtractor 82 which is for inputting to the axial force estimating section 84 a motor axial force current proportional to a motor axial force Frm due to the assist motor 44, subtracts the addition value of the friction compensation current Ifr and the inertia compensation current Iin (Ifr+Iin) from the motor actual current Iact, and obtains a difference {Iact−(Ifr+Iin)}.

As a result, the inertia compensation current Iin being a compensation current of an inertia portion of the assist motor 44, and the friction compensation current Ifr being a compensation current of a friction portion of the worm gear mechanism 46, and so on, can be removed from the motor actual current Iact, so the motor axial force Frm [∝{Iact−(Ifr+Iin)}] (where ∝ is a proportional sign) due to the assist motor 44 in a rack axial force Fr can be estimated.

In other words, the subtractor 82 substantively functions as an estimating section of the motor axial force (the rack axial force) Frm due to the assist motor 44 (refer to FIG. 1, an axial force due to the torque assist mechanism 16).

On the other hand, the subtractor 83 which is for inputting to the axial force estimating section 84 a torque of the pinion shaft 30 (a rack axial force Frs: refer to FIG. 1) that occurs due to operation of the steering wheel 22 by the driver, subtracts the friction compensation torque Tfr from the steering torque Ts to obtain a difference (Ts−Tfr).

Since the friction compensation torque Tfr in the rack axial force Frs can be removed in this way, then the rack axial force Frs (∝(Ts−Tfr)) due to operating input (so-called manual input) in the rack axial force Fr can be estimated.

The axial force estimating section 84 for estimating the rack axial force Fr estimates the rack axial force Fr (Fr=Frs+Frm) by adding the motor axial force Frm to the rack axial force (an axial force due to the steering mechanism 14) Frs (refer to FIG. 1) estimated from the steering torque Ts, and inputs a thereby-estimated rack axial force (an estimated rack axial force) Fer to a minuend terminal of the subtractor 86.

The subtractor 86, by subtracting from and thereby removing from the estimated rack axial force Fer a viscosity compensation axial force Fvc appropriate to the viscosity compensation current Ivc, that has been generated by the current/axial force conversion section 81, inputs an estimated rack axial force Fere (Fere=Fer−Fvc) shared by the base control section 66, to the reference characteristics section 110.

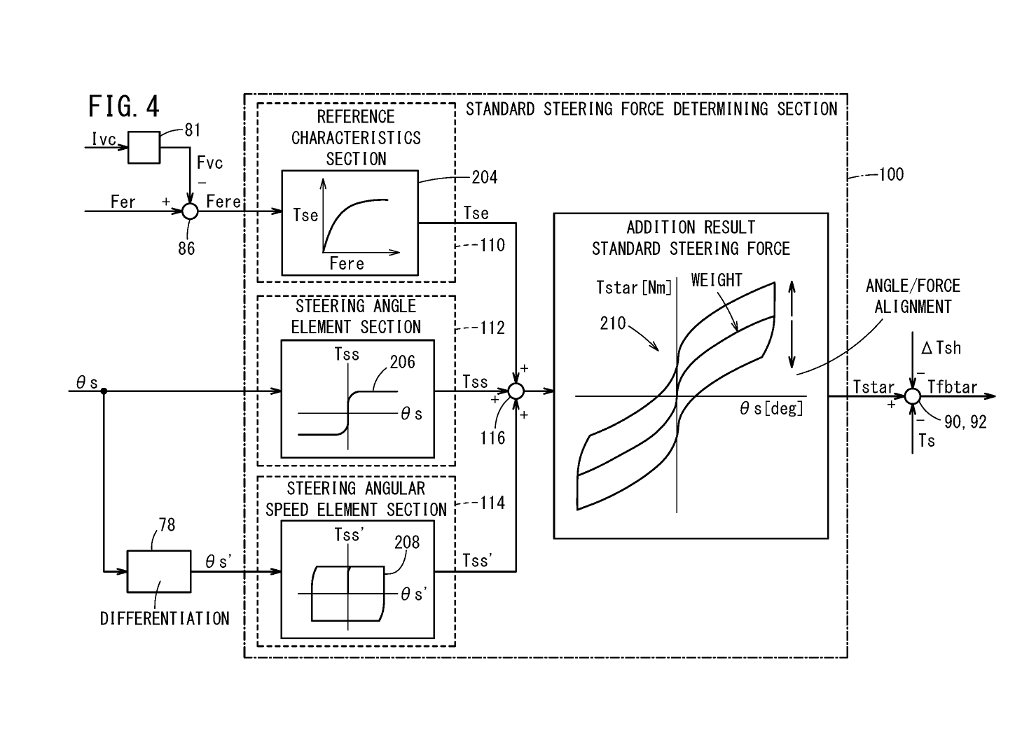

FIG. 4 is a block diagram showing a detailed configuration of the standard steering force determining section 100 and its input/output configuring elements. Note that the standard steering force determining section 100 is provided for optimizing a response of handle operation to improve steering comfort and maneuverability.

The reference characteristics section 110 includes an inverse base assist map (inverse base assist characteristics) 204 having inverse characteristics of the base assist map (the base assist characteristics) 202 shown in FIG. 3, generates with reference to the inverse base assist map 204 an estimated steering torque Tse corresponding to the estimated rack axial force Fere, and outputs the estimated steering torque Tse to the adder 116.

Note that the inverse base assist map 204 largely has a shape of an inverse function of the base assist map 202 (refer to FIG. 3), that is, a power function-like shape. In effect, the inverse base assist map 204 is formed such that with the vehicle speed Vv as a parameter, the higher the vehicle speed Vv becomes, the larger a value the estimated steering torque Tse will take.

Now, the steering angle element section 112 and the steering angular speed element section 114 function as angle/force alignment elements.

The steering angle element section 112 includes an angle/force alignment element map 206, converts to a steering angle torque Tss depending on the steering angle θs, and outputs the steering angle torque Tss to the adder 116.

The steering angular speed element section 114 includes a hysteresis alignment element map 208, converts the steering angular speed θs′ to a steering angular speed torque Tss′ having hysteresis, and outputs the steering angular speed torque Tss′ to the adder 116.

As shown in FIG. 4, an addition result due to the adder 116 (Tse+Tss+Tss′) becomes standard steering force characteristics (target steering force characteristics) 210 obtained by the inverse base assist map (inverse base assist characteristics) 204 that forms a basis of weight of operation by the driver of the steering wheel 22, being angle/force alignment (hysteresis alignment) in a torque direction.

In this way, a standard steering force (a target steering force) Fstar [N] and a corresponding standard steering torque (target steering torque) Tstar [Nm] are determined by the standard steering force determining section 100.

The horizontal axis of the standard steering force characteristics 210 shown in FIG. 4 is the steering angle θs [deg], and the vertical axis is assumed to be the target steering torque (the standard steering torque) Tstar [Nm] corresponding to the standard steering force.

That is, the standard steering force determining section 100 is inputted with the estimated rack axial force Fere, the steering angle θs, and the steering angular speed θs′, whereby first, in the reference characteristics section 110, the steering angle element section 112, and the steering angular speed element section 114, it respectively generates the estimated steering torque Tse, the steering angle torque Tss, and the steering angular speed torque Tss′.

Then, the generated estimated steering torque Tse, steering angle torque Tss, and steering angular speed torque Tss′ are added (synthesized) by the adder (the synthesizer) 116 to generate (determine) the standard steering torque (the target steering torque) Tstar corresponding to the standard steering force appropriate to the steering angle θs.

The target steering torque Tstar generated by the standard steering force determining section 100 is inputted to a minuend terminal of the subtractor 90.

Next, the hysteresis torque ΔTsh is subtracted from the target steering torque Tstar by the subtractor 90, the steering torque Ts is further subtracted from that subtraction result by the subtractor 92, and a feedback target steering torque (FB target steering torque) Tfbtar is generated as a subtraction result, and inputted to the PID control section 94.

The PID control section 94 PID (proportion/integration/differentiation)-controls the FB target steering torque Tfbtar and generates the FB target current Ifbtar to be outputted to the adder 75.

In this case, the FF target current Ifftar and the FB target current Ifbtar are added by the adder 75 in the FF control section 71, whereby the target current Itar is generated.

Next, the motor actual current Iact to be inputted to the assist motor 44 is PID (proportion/integration/differentiation) feedback-controlled by the current FB section 80 so as to become the target current Itar.

The assist motor 44 is driven by the motor actual current Iact that has been matched to the target current Itar, outputted from the current FB section 80.

By drive-controlling the assist motor 44 in this way, a catching feeling during turning-back is significantly reduced in the electric power steering device 10.

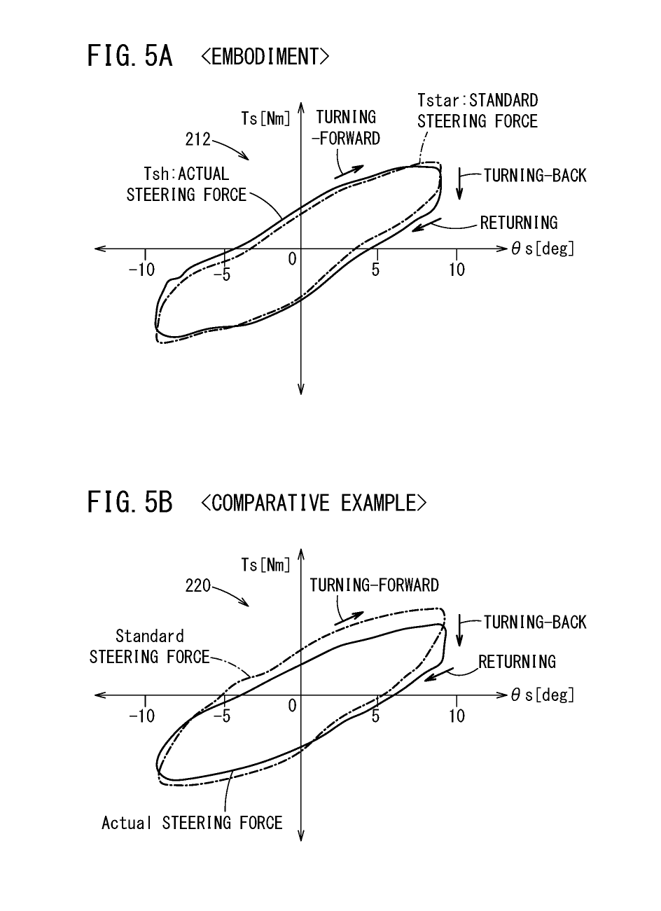

FIG. 5A shows angle/force characteristics 212 after improvement according to the embodiment, and FIG. 5B shows angle/force characteristics 220 before improvement according to a comparative example.

The angle/force characteristics 212, 220 show characteristics of standard steering force (target steering torque) Tstar which is indicated by a one dot-chain line and actual steering force Tsh which is indicated by a solid line, in the case where turning-forward, turning-back, and returning operations have been performed at vehicle speed Vv=60 [km/h], steering angle θs≈±10 [deg], and steering repetition period 1 [Hz].

In the angle/force characteristics 220 according to the comparative example, catching is felt during turning-back, but in the angle/force characteristics 212 according to the embodiment, catching during turning-back is improved.

### SUMMARY

As described above, the electric power steering device 10 according to the above-mentioned embodiment is an electric power steering device in which a steering assist force appropriate to operation of the steering wheel (a steering) 22 is applied to the steering mechanism 14 by the assist motor 44, and includes: the torque sensor 38 configured to detect the steering torque Ts due to the operation of the steering wheel 22; the current sensor 61 configured to detect the motor actual current Iact flowing in the assist motor 44; and the FB control section (the controller) 72 configured to estimate by means of an axial force estimating section 84 the rack axial force Fer (in FIG. 2, an output of the axial force estimating section 84), depending on the steering torque Ts and the motor actual current Iact, calculate by means of the standard steering force determining section (the standard steering torque determining section) 100 the standard steering torque Tstar corresponding to the standard steering force of the steering wheel 22, based on the estimated rack axial force Fer, and feedback-control the motor actual current Iact in a manner that the steering torque Ts of the steering wheel 22 will be the standard steering torque Tstar (the standard steering force).

Due to the present embodiment, the steering torque Ts of the steering wheel 22 is controlled so as to be the standard steering torque Tstar (the standard steering force), so stability of steering force with respect to the operation of the steering wheel 22 is improved, and as a result, as shown in FIG. 5A, a catching feeling during turning-back of the steering wheel 22 can be suppressed.

In this case, there is further included the resolver 60 as the rotation angle sensor configured to detect the motor rotation angle θm of the assist motor 44, so the FB control section 72 is configured to calculate the standard steering torque Tstar (the standard steering force), based on the steering angle θs and steering angular speed θs′ calculated from the motor rotation angle θm, in addition to the estimated rack axial force Fer. Thus, calculation accuracy of the standard steering torque Tstar (the standard steering force) can be increased, and stability of steering force with respect to operation of the steering wheel 22 is more improved.

In this case, the FB control section 72 is configured to set the estimated rack axial force Fer to the rack axial force Fere from which a viscosity compensation axial force Fvc based on a viscosity compensation current Ivc has been removed. Thus, calculation accuracy of the standard steering torque Tstar (the standard steering force) can be further increased, and stability of steering force with respect to operation of the steering wheel 22 can be even more improved.

Note that the present invention is not limited to the above-mentioned embodiment, and may of course adopt a variety of configurations based on content described in the present specification.

What is claimed is:

1. An electric power steering device in which a steering assist force appropriate to steering operation is applied to a steering mechanism by an assist motor, comprising:
a torque sensor configured to detect a steering torque due to the steering operation;
a current sensor configured to detect a motor current flowing in the assist motor; and
a controller configured to estimate a rack axial force depending on the steering torque and the motor current, calculate a standard steering force of the steering based on the estimated rack axial force, and feedback-control the motor current in a manner that the steering torque of the steering will be the standard steering force.

2. The electric power steering device according to claim 1, further comprising a rotation angle sensor configured to detect a rotation angle of the assist motor,
wherein the controller is configured to calculate the standard steering force, based on a steering angle and a steering angular speed calculated from the rotation angle, in addition to the estimated rack axial force.

3. The electric power steering device according to claim 2, wherein the controller is configured to set the estimated rack axial force to a rack axial force from which a viscosity compensation axial force based on a viscosity compensation current has been removed.
